(19) United States
(12) Patent Application Publication
(10) Pub. No.: US 2023/0070638 A1
(43) Pub. Date: Mar. 9, 2023

(54) Device and Method for Erecting a Wind Turbine with a Tower and Two Booms Extending from the Tower

(71) Applicant: Aerodyn Consulting Singapore PTE LTD, Singapore (SG)

(72) Inventor: Sönke SIEGFRIEDSEN, Rendsburg (DE)

(73) Assignee: Aerodyn Consulting Singapore PTE LTD, Singapore (SG)

(21) Appl. No.: 17/800,024

(22) PCT Filed: Mar. 22, 2021
(86) PCT No.: PCT/IB2021/052352

§ 371 Date: Aug. 16, 2022

(30) Foreign Application Priority Data
Mar. 25, 2020 (DE) 10 2020 108 154.5

(51) Int. Cl. F03D 13/10; B63B 35/34; B63B 35/44; B63B 75/00

(52) U.S. Cl. CPC F03D 13/10; B63B 35/34; B63B 35/44; B63B 75/00; F05B 2230/6102; B63B 2035/446

(57) ABSTRACT

Device for erecting a wind turbine with a floating foundation, a tower arranged on the floating foundation and two booms extending from the tower, with an energy conversion unit that is arranged in each case at a free end of a boom and has a rotor, characterized by an auxiliary tower with a rope system, connected to a winch, for lifting the energy conversion units that are connected by the booms to the tower of the wind turbine.

The invention relates to a device and a method for erecting a wind turbine with a tower and two booms, extending from the tower, with an energy conversion unit that is arranged in each case at a free end of a boom and has a rotor.

Such a wind turbine arranged on a floating foundation is known in principle from WO 2007/206976 A2. This floating wind turbine, the total output of which is composed of several, already tested and approved, individual systems and can therefore be implemented with relatively little expenditure of time and effort, uses the Y-shaped floating foundation known from EP 3 019 740 B1, which has proven to be very advantageous in several (unpublished) tests with regard to the absorption of loads occurring on the energy conversion unit as well as with regard to the floating stability of the entire system under load.

As known from DE 10 2016 118 078 A1, the foundation is constructed from a plurality of concrete elements in a modular manner, wherein the individual concrete elements can be produced using the casting mold known from WO 2019/234 488 A2 and can be mounted using the mounting system also mentioned in this PCT application.

A hitherto practically unsolved problem in the production of a particularly preferred embodiment of the wind turbine known from WO 2007/206976 A2 is that the plant is to ideally get its stability only by bracing the foundation with the energy conversion units arranged on the booms. In order to save material and thus weight, this means that the booms are preferably designed in such a way that they alone, i.e., without anchoring, will not be able to absorb the high weight of the energy conversion units.

Therefore, the problem to be solved in the present case does not consist in the fact that the wind turbine known from WO 2007/206976 A2 could not be manufactured as such, but rather in how a production method of a wind turbine known from WO 2007/206976 A2 must be designed so that a particularly advantageous erection of a particularly advantageous wind turbine can be accomplished.

The aim of the invention is therefore to provide a method and a device for erecting a wind turbine of the type mentioned at the outset.

This aim is achieved according to the invention by the device having the features of claim 1, the harbor having the features of claim 20, and the method according to 22. Each of the dependent claims describes advantageous embodiments of the invention.

According to the invention, a device for erecting a wind turbine having a floating foundation, a tower arranged on the floating foundation, and two booms, extending from the tower, with an energy conversion unit that is arranged in each case at a free end of a boom and has a rotor, is therefore proposed, which has an auxiliary tower with a rope system, connected to the winch, for lifting the energy conversion units connected by means of the booms to the tower of the wind turbine.

The device is configured in particular for the synchronous lifting of the energy conversion units connected by means of the booms to the tower of the wind turbine. In particular, the device has a slipway which is arranged adjacent to the auxiliary tower and which accommodates the floating foundation, so that the finished product can be easily delivered.

A device is preferably provided for erecting a wind turbine having a floating foundation, a tower arranged on the floating foundation, and two booms, extending from the tower, each having an energy conversion unit arranged at a free end of a boom and having a rotor, which turbine has a first pontoon for holding the floating foundation, two second pontoons each for holding an energy conversion unit, wherein the second pontoons are arranged on opposite sides of the first pontoon, and an auxiliary tower arranged centrally to the second pontoons and having a rope system, connected to a winch, for lifting the tower of the wind turbine connected by means of the booms to the energy conversion units from the second pontoons.

Regardless of whether an embodiment is with or without slipway or pontoons, the rope system, connected to the winch, of the auxiliary tower is preferably designed in such a way that the booms supported on the tower—in particular, connected in an articulated manner to the tower—are lifted at the same time by an identical amount, so that the dead weight moments of the booms and the energy conversion units acting on the auxiliary tower cancel one another out due to the synchronous lifting of the booms. Since there are almost no bending moments, but only compressive forces acting on the auxiliary tower, the auxiliary tower can be manufactured with relatively little material expenditure. If several winches are used, they must be harmonized with one another for synchronous lifting of the booms.

If pontoons are provided, they are preferably designed as floating platforms made of concrete and/or steel and configured as water-level-dependent carriers for holding components of the floating wind turbine to be erected using the device, wherein the first pontoon is designed in particular to be submersible; the first pontoon is thus functionally designed as a simple floating dock. For this purpose, the first pontoon preferably has a plurality of chambers which can be flooded and emptied by means of at least one pump and thereby determine the buoyancy of the first pontoon. Specifically, a control for trimming the first pontoon is provided which stabilizes the first pontoon in the horizontal direction during the production process of the floating wind turbine.

The first pontoon is further preferably formed from a plurality of pontoon elements connected to one another which, depending upon requirements, are adapted to the shape of the floating foundation of the wind turbine to be erected by means of the device. Thus, the first pontoon preferably has at least one conveying path for transporting foundation modules that make up the floating foundation. Specifically, there are three, star-shaped conveying paths converging towards a central connecting part, with which paths the known Y-shaped floating foundation of the wind turbine mentioned at the outset can be assembled in a simple manner.

The end face of the first pontoon and the end faces of the second pontoons are preferably aligned with one another, wherein connecting elements that connect the first pontoon to the second pontoons are provided. According to a further preferred embodiment, these connecting means are designed as spacers, which effect a predetermined spacing between the pontoons and which are particularly preferably connected in an articulated manner to both the first pontoon and to the second pontoons. Most preferably, the joints formed between the pontoons and the spacer have a single degree of freedom and are configured to be rotatable about an axis arranged in the plane of the pontoons, so that a movement of the second pontoons relative to the first pontoon is possible in terms of height, but not horizontally.

If pontoons are provided, the auxiliary tower is preferably arranged on the first pontoon so that it is also lowered when the first pontoon is lowered. The winch is preferably arranged in the tower or in the foundation, formed by the first pontoon, of the auxiliary tower.

According to an alternative embodiment, the device can have a recess formed in the first pontoon which at least partially surrounds the auxiliary tower, wherein the first pontoon is arranged displaceably along the longitudinal axis of the auxiliary tower. For this reason, it is necessary to base the auxiliary tower on the bottom of the harbor basin.

In any event, if the device is designed with pontoons, the auxiliary tower is arranged not only centrally to the second pontoons, but particularly preferably centrally between the second pontoons.

In any case, the device must be designed in such a way that the ropes leading from the auxiliary tower to the booms arranged on both sides of the auxiliary tower are in alignment, so that the bending moments acting on the auxiliary tower can be largely reduced. In other words, the device is to be designed and arranged in relation to the wind turbine to be erected in such a way that the attachment points provided on the booms (or on the energy conversion units) for connecting the booms to the rope system and the auxiliary tower are arranged on an imaginary straight line.

In addition, a block and tackle arranged in the auxiliary tower and communicating with the winch is provided which particularly preferably has a block which is configured displaceably along the longitudinal axis of the auxiliary tower and which is connected to the rope system for lifting the energy conversion units connected by means of the booms to the tower of the wind turbine. Most preferably, the displaceably-configured block is displaceably configured by means of a lift, so that it can be lifted back into its starting position after a lifting process has been carried out.

Finally, the auxiliary tower is preferably designed as a crane, having a crane boom, with which the components making up the wind turbines can be transported to the place of use. The crane boom is preferably configured to be rotatable about the auxiliary tower, wherein the first pontoon is arranged in the pivoting range of the crane boom if the device is designed with pontoons.

Specifically, the auxiliary tower has a crane boom on which a trolley is provided that can be moved along the crane boom and is equipped with a lift, wherein the crane boom is particularly preferably configured to be rotatable 360° about the longitudinal axis of the auxiliary tower. The auxiliary tower thus serves on the one hand to transport the loads of the components forming the wind turbine on land, or, in some cases, between the mainland and the preferably provided pontoons. On the other hand, the auxiliary tower is equipped with a rope system, having a winch, which is required for lifting the energy conversion units (in some cases, from the second pontoons) connected by means of the booms to the tower of the wind turbine. The preferred embodiment ensures that every position of the floating foundation to be produced of the wind turbine to be erected can be reached by the trolley, which is movable on the crane boom, of the centrally-installed auxiliary tower, without the need for any further means of transport.

Furthermore, a harbor with a quay and a device attached in a floating manner to the quay are also proposed according to the invention. In the present case, a harbor is understood to be an area on a sea coast or on the bank of a river where ships can dock. Such a harbor consists in particular of at least one harbor basin and at least one quay, i.e., a bank fortified by walls, wherein the bank in front of the quay wall is deep enough that ships can moor at the quay. If this proves to be advantageous due to local conditions, the harbor can also have a pier or be partially surrounded by a pier. In any case, the harbor is to be configured in such a way that the quay is freely accessible for the device, and the wind turbine completed by means of the device according to the invention can be towed out of the harbor by means of at least one tug and brought to the place of its installation.

The harbor extends in particular on the water side along a straight quay, the length of which is somewhat greater than twice the rotor diameter of a single rotor of the wind turbine to be manufactured. When a single rotor diameter is 200 m, the quay will accordingly have a straight design over a length of approximately 500 m. The water depth of the harbor is to be dimensioned in such a way that the wind turbine to be produced can be towed out of the harbor and is advantageously at least 8 to 10 m, wherein the tidal range has to be taken into account where applicable.

The device according to the invention can be manufactured in the harbor itself or in a dock adjacent to the port, towed into the harbor in individual parts, and mounted there.

The harbor has an advantageous design if, when the harbor is designed with pontoons, it has a second conveying path arranged on the quay and communicating with a conveying path arranged on the first pontoon. This allows foundation elements to be conveyed from the harbor directly to the first pontoon without any further aids being required.

The method embodied according to the invention for erecting a wind turbine having a floating foundation, a tower arranged on the floating foundation, and two booms, extending from the tower, with an energy conversion unit that is arranged in each case at a free end of a boom and has a rotor, provides, in a first step, for the creation of a floating foundation with a tower arranged thereon. At least one support arranged on the tower is then configured to receive one end of each of the booms, each of which may in some cases be pre-assembled with an energy conversion unit. The support, which can either be temporarily mounted on the tower and dismantled after its use or is designed as an integral part of the tower, is also referred to below as a tower connector and is designed in particular as a joint that connects the tower to the booms in an articulated manner. Then one end of the boom is placed on the support, and the other end of the boom is positioned at the height of the tower base. The other end, mounted at the height of the tower base, of each of the booms is lifted for erection of the turbine as the booms are simultaneously pivoted with the at least one support acting as a seat until a predetermined height is reached, whereupon the one ends of the pivoted boom are fixed on the tower, i.e., are firmly connected thereto, wherein an anchoring device is formed by means of at least one guy rope between the other ends of the pivoted booms or between the energy conversion units.

The booms are preferably lifted in such a way that the booms are lifted synchronously by an identical amount in each case. Due to the synchronized lifting of the booms, the dead weight moments of the booms and the energy conversion units acting on the auxiliary tower cancel one another out, so that the auxiliary tower does not have to be designed to be particularly massive, because there are almost no bending moments, but only compressive forces, acting on the auxiliary tower.

If the rotor of the energy conversion units has not been mounted on the booms from the start, it is preferably provided that the rotors be attached to the energy conversion units after the booms have been pivoted and fastened to the tower and anchored to one another.

Basically, depending upon the number of blades used, the following options arise for mounting the rotor: If the floating wind turbine is to be equipped with two, two-bladed rotors, it is advantageous to mount the rotors on the energy conversion units before lifting the booms, wherein the two-bladed rotors are arranged in such a way that the blades of the rotors extend horizontally. Alternatively, the two-blade rotors can also be attached to the energy conversion units after the booms have been lifted.

If, on the other hand, three-blade rotors are provided, the rotors with their three blades are preferably mounted lying in a horizontal plane, lifted together as a unit, pivoted 90°, and attached to the energy conversion units that have already been lifted. Alternatively, rotors pre-assembled with just two of the three blades can also be attached to the energy conversion units before the booms are lifted, wherein the third blade in each case is attached after the boom has been lifted.

One of the devices designed according to the invention is particularly preferably used to carry out the method according to the invention.

The invention is explained in greater detail below with reference to a particularly preferred embodiment shown in the attached drawings. Shown are:

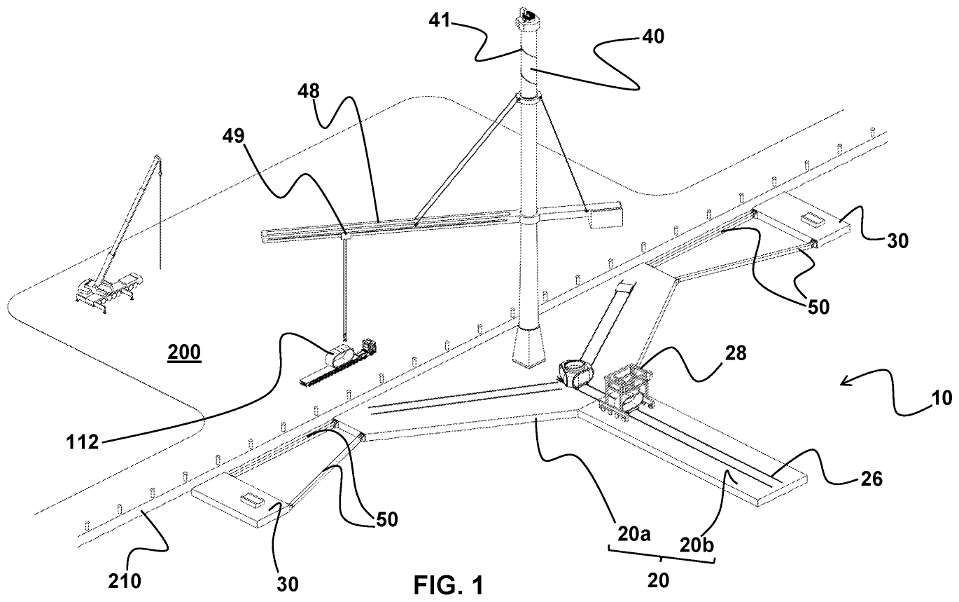

FIG. 1 a particularly preferably designed harbor during a first production step for erecting a particularly preferably designed floating wind turbine which has two booms, connected to a tower, on each end of which an energy conversion unit having a rotor is arranged;

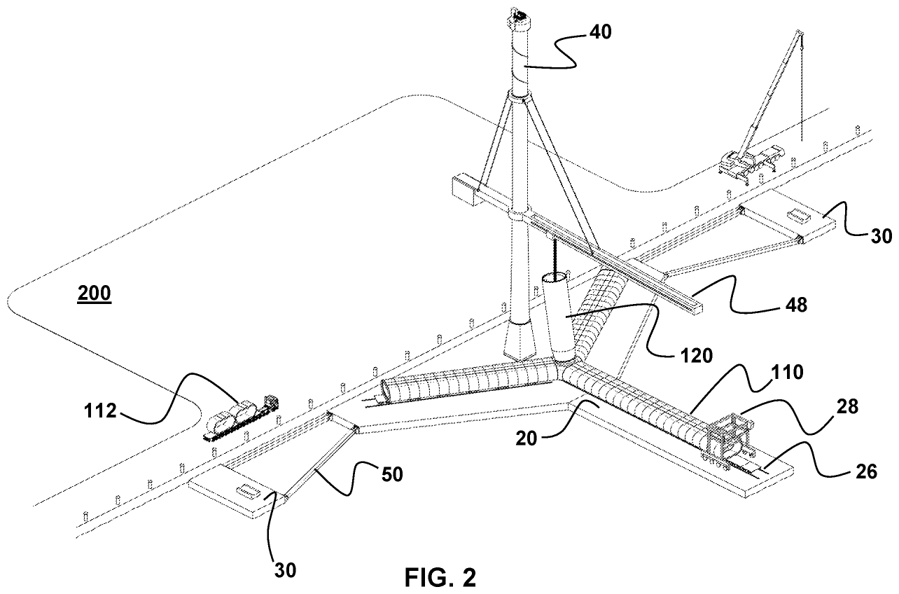

FIG. 2 the previously described harbor during a second production step with the foundation almost completely finished;

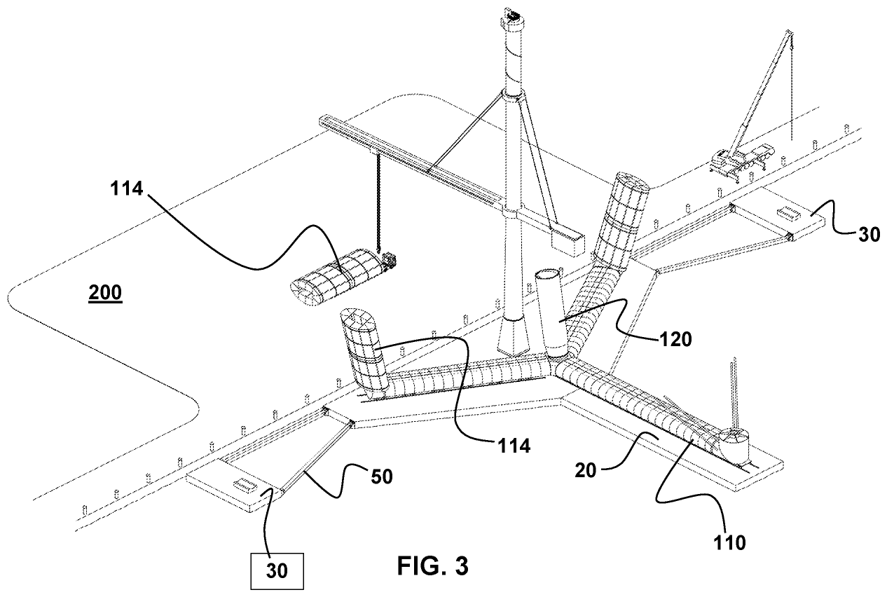

FIG. 3 the previously described harbor during a third production step while the floating bodies are being attached to the floating foundation;

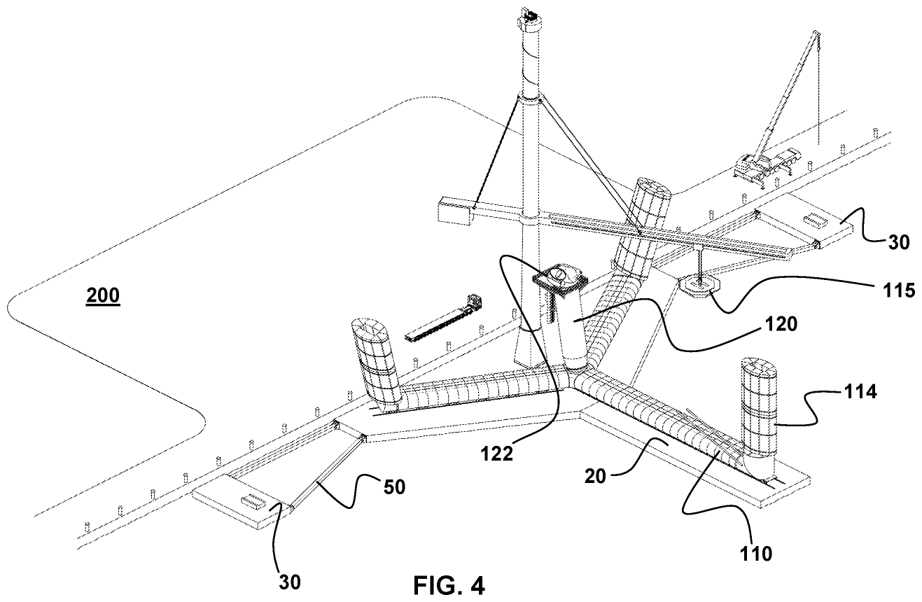

FIG. 4 the previously described harbor during a fourth production step after connection of the floating bodies to the foundation;

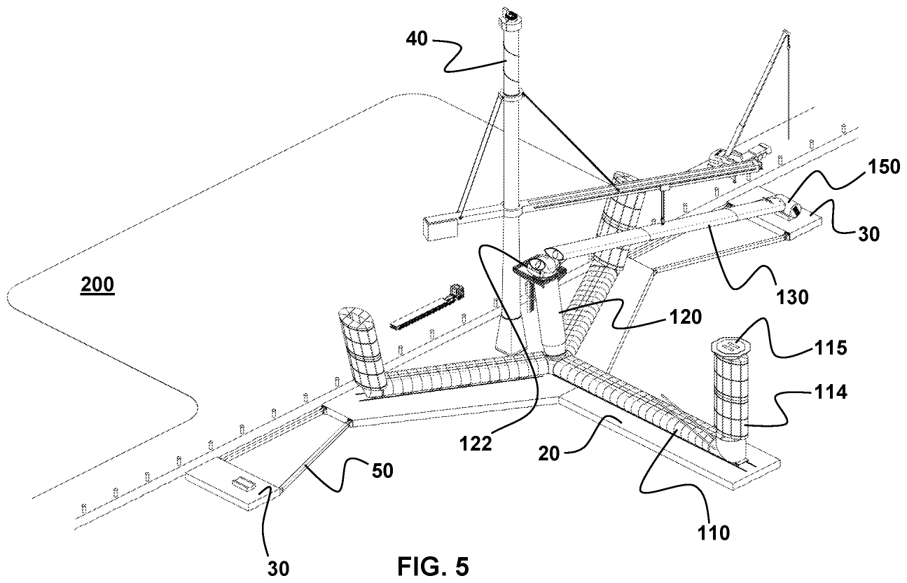

FIG. 5 the previously described harbor during a fifth production step in preparation for connecting the two booms to the tower;

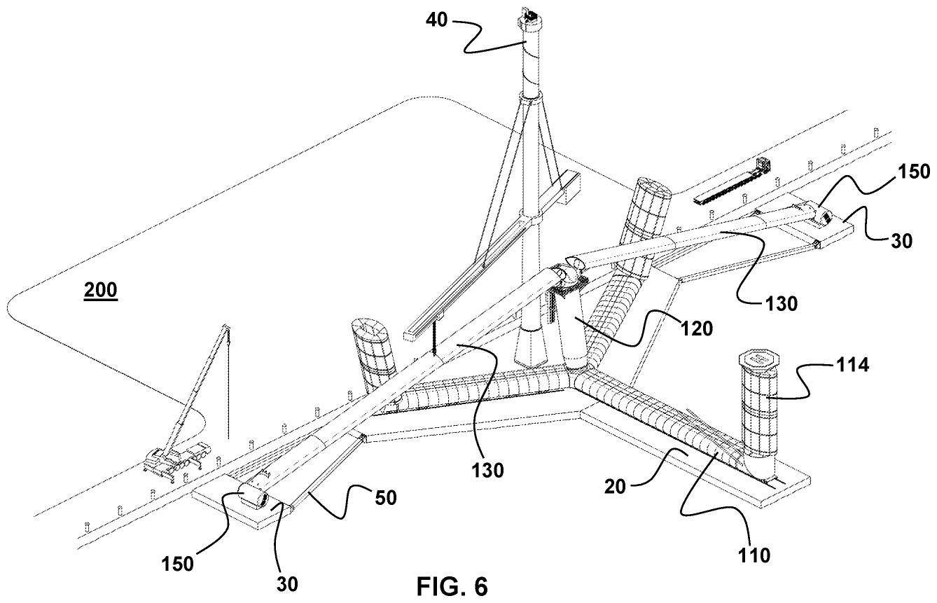

FIG. 6 the previously described harbor during a sixth production step with booms connected to the tower;

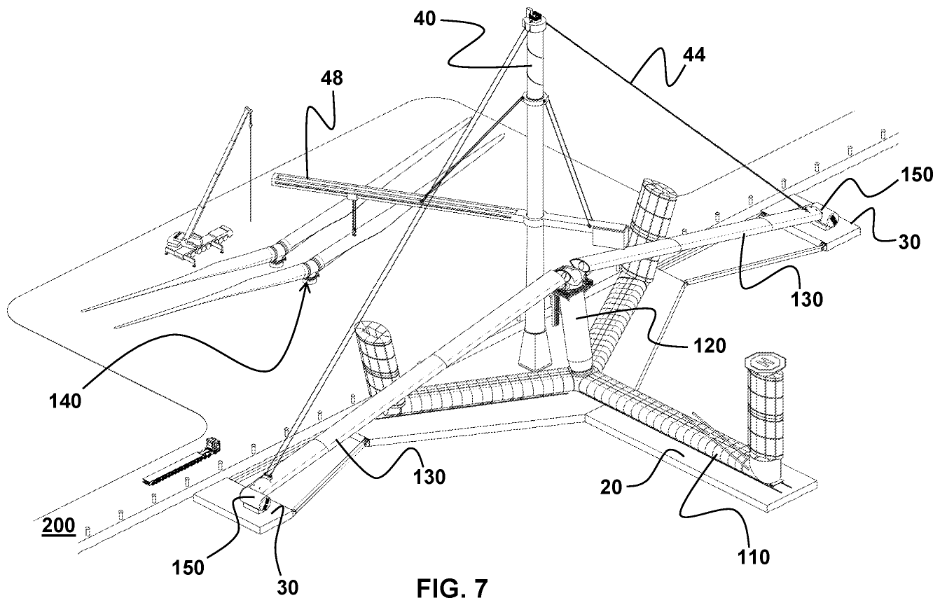

FIG. 7 the previously described harbor during a seventh production step after the connection to the booms of the auxiliary ropes necessary for the erection;

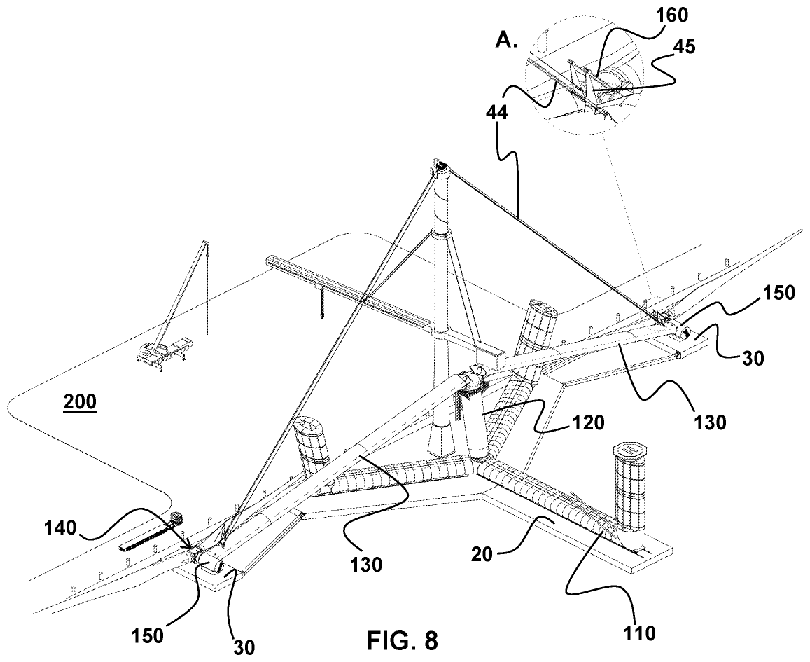

FIG. 8 the previously described harbor during an eighth production step after connection of the guy ropes, which are provided for anchoring the booms, to one another;

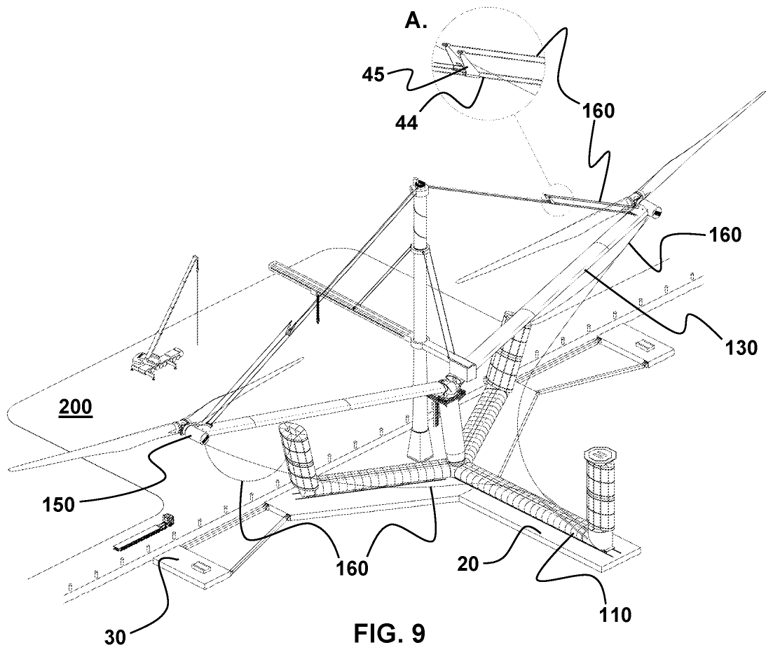

FIG. 9 the previously described harbor during a ninth production step during the lifting of the energy conversion units;

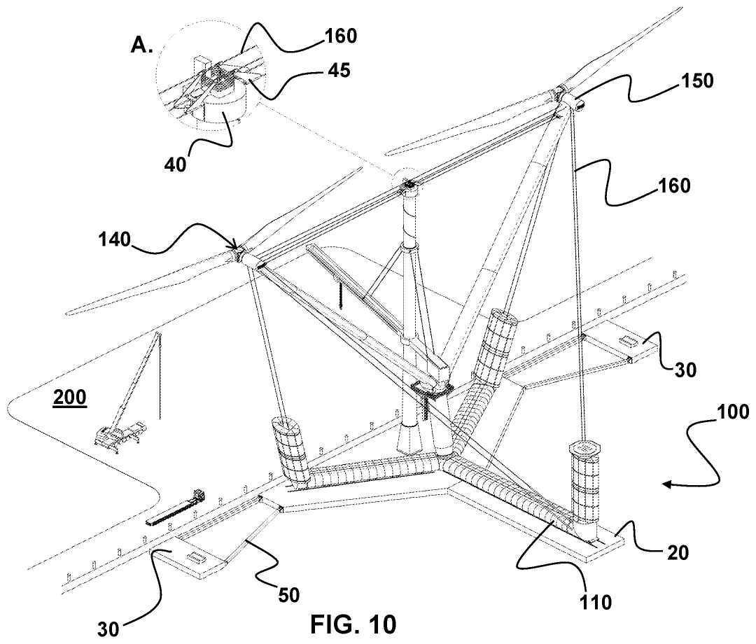

FIG. 10 the previously described harbor during a tenth production step with fully-lifted energy conversion units;

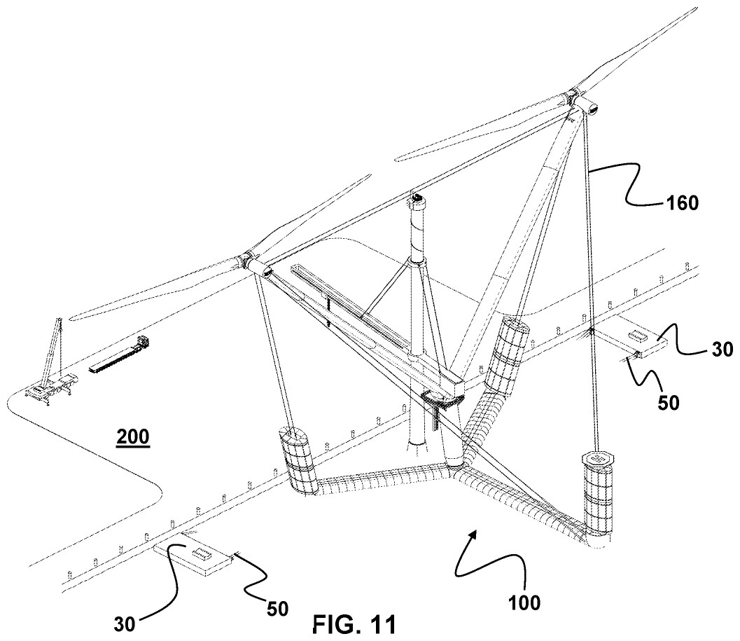

FIG. 11 the previously described harbor after completion of the floating wind turbine with the first pontoon lowered;

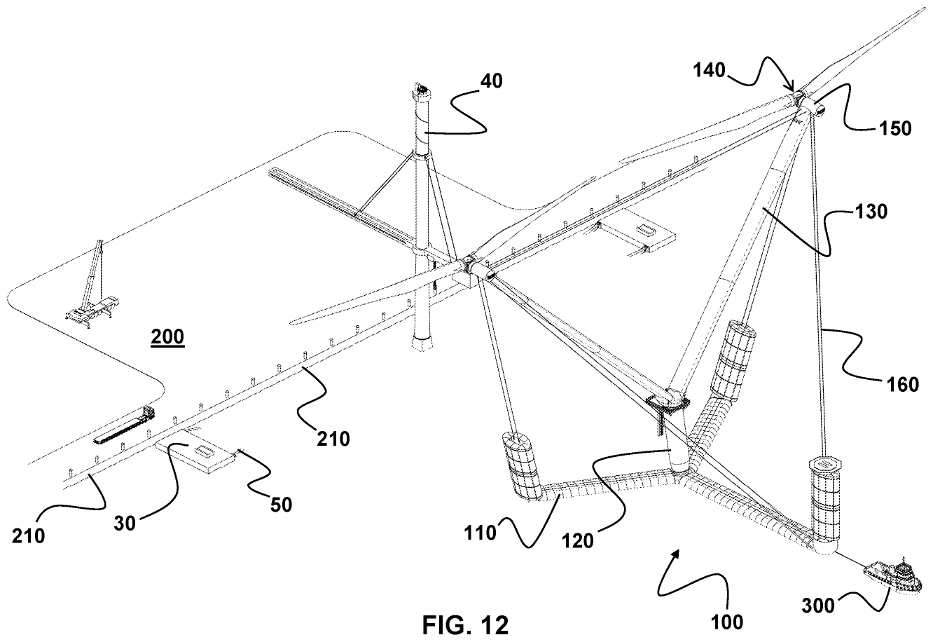

FIG. 12 the completed floating wind turbine being towed out of the harbor;

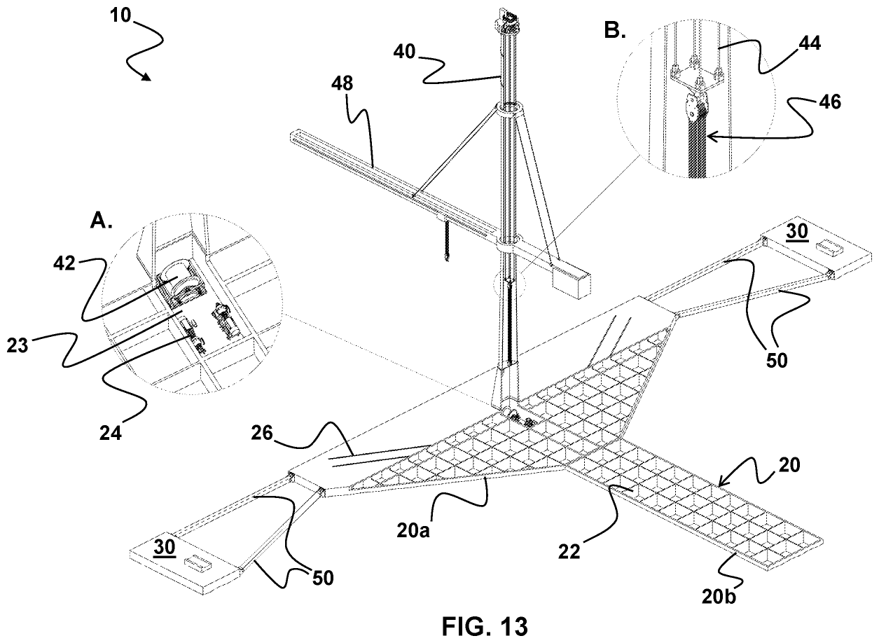

FIG. 13 a partial section view of a particularly preferably designed device for erecting the floating wind turbine shown above, with two booms, connected to a tower, on each end of which an energy conversion unit having a rotor is arranged; and

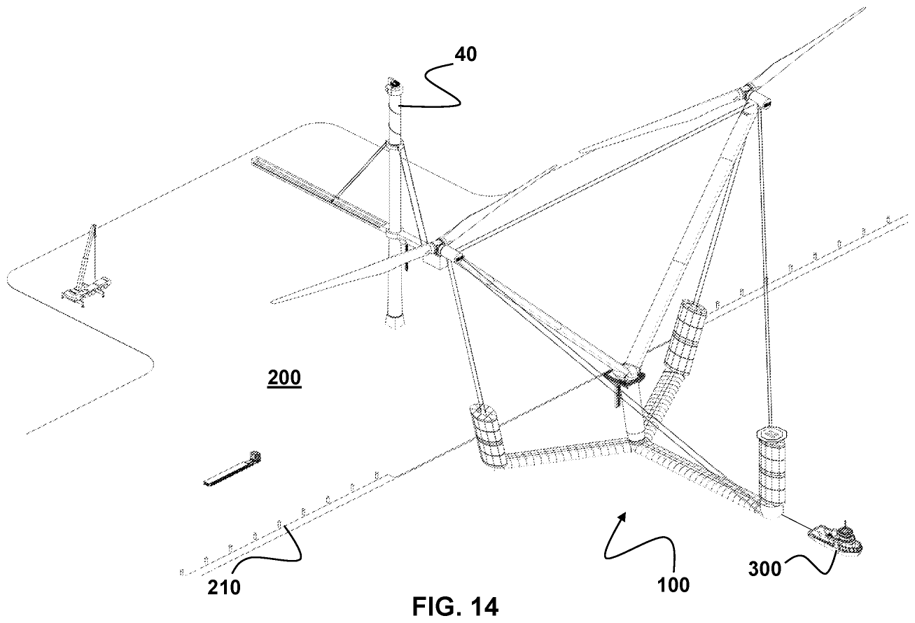

FIG. 14 a particularly preferably designed harbor according to a further embodiment after completion of a particularly preferably designed floating wind turbine while the system is being towed out of the port.

FIG. 1 shows a particularly preferably designed harbor during a first production step for erecting a particularly preferably designed floating wind turbine which has two booms, connected to a tower, on each end of which an energy conversion unit having a rotor is arranged.

The particularly preferably designed harbor 200 preferably has a paved surface, which is designed in particular so that it can be driven on and is configured for the storage of components of the wind turbine to be manufactured. For example, roads including lane markings can be provided that regulate the flow of traffic, but buildings that can be used for the administration of the harbor or the storage of wind turbine components in a manner protecting them from environmental influences (not shown) can also be provided. The harbor 200 extends on the water side along a rectilinear quay 210, the length of which is somewhat greater than twice the rotor diameter of an individual rotor of the wind turbine to be manufactured. If a single rotor diameter is 200 m, the quay 210 will accordingly have a straight design over a length of approximately 500 m. The water depth of the harbor 200 is to be dimensioned in such a way that a wind turbine completed by means of the device can be lowered in the harbor 200 and towed out of the harbor 200. The water depth of the harbor 200, taking into account the height of the first pontoon on which the completed wind turbine is arranged, and the draft of the floating wind turbine is therefore, advantageously, at least 10 to 15 m, wherein the tidal fluctuation in harbor 200 also has to be taken into account if necessary.

In front of the quay 210 and extending essentially parallel to the quay wall of the harbor 200, there is a particularly preferably designed device 10 for erecting a wind turbine having a floating foundation, a tower arranged on the floating foundation, and two booms, extending from the tower, each having an energy conversion unit that is arranged on a free end of a boom and has a rotor. The particular structure of the wind turbine to be erected with the aid of the device is made clear in the following by explanation of the individual preferred production steps.

The device 10 used for this purpose in any case has a first pontoon 20 for holding the floating foundation of the wind turbine, two second pontoons, each for holding an energy conversion unit of the wind turbine and each arranged on an opposite side of the first pontoon 20, and an auxiliary tower 40 arranged centrally to the second pontoons 30. In particular, the auxiliary tower 40 is arranged on the first pontoon 20 in the example shown and is specifically designed as a crane. For this purpose, the auxiliary tower 40 has a crane boom 48 on which a trolley 49 which can be moved along the crane boom 48 and is equipped with a lift is provided, wherein the crane boom 48 is particularly preferably configured to be rotatable 360° about the longitudinal axis of the auxiliary tower 40. The auxiliary tower 40 thus serves, on the one hand, to transport loads of the components forming the wind turbine between the mainland and the pontoons 20, 30. On the other hand, the auxiliary tower—as will be shown below—is equipped with a rope system, having a winch, which is required for lifting the energy conversion units, connected by means of the booms to the tower of the wind turbine, from the second pontoons.

The auxiliary tower 40 is arranged centrally on the first pontoon 20 and in a plane with the second pontoon 30. In particular, the auxiliary tower 40 is arranged in the longitudinal axis of the second pontoon element 20b extending perpendicular to the quay 210. Furthermore, to stabilize the auxiliary tower 40, a Scruton helix 41 is provided at least in sections and reduces oscillations of the tower 40 caused by the wind flowing around the auxiliary tower 40. This is particularly advantageous for the illustrated case in which the tower 40 is arranged on the first pontoon 20.

The first pontoon 20 preferably has a two-part design and essentially follows the shape of the floating foundation to be produced for the floating wind turbine. In particular, a first pontoon element 20a extends parallel to the quay 210, and a second pontoon element 20b extends perpendicular to the quay 210, wherein the first pontoon element 20a and the second pontoon element 20b, after their manufacture, which can also be carried out in the harbor configured for the erection of the wind turbine, and their relative positioning to one another, are connected to one another in such a way that a relative movement between these elements is prevented.

The first pontoon 20—more precisely, the first pontoon element 20a—is connected, on its two sides extending perpendicularly from the quay 210, in each case to one of the second pontoons 30 with the aid in each case of two spacer elements 50. The spacer elements 50 are connected in an articulated manner to both the first pontoon 20 and to the second pontoon 30, wherein the joints have a degree of freedom and are each configured to be rotatable about an axis extending perpendicularly from the quay 210. This allows a mobility of the second pontoons 30 relative to the first pontoon 20 in terms of height, i.e., in the vertical direction, e.g., to adapt to waves, but not in their relative horizontal position. This ensures that the sides of the first pontoon 20 and the second pontoons 30 facing the quay 210 are always in alignment and can terminate with the quay 210.

The first pontoon 20, which is configured for the sole purpose of holding the wind turbine completed after production, has three, star-shaped conveying paths 26 converging towards a central connecting part and which have proven to be advantageous in the manufacture of the floating foundation of the wind turbine. For this purpose, individual foundation modules 112 forming the floating foundation are manufactured in a factory configured for this purpose and are transported to the harbor 200. The auxiliary tower 40 configured as a crane lifts the foundation modules 112 onto the conveying path 26 configured on the first pontoon 20, on which the individual foundation modules 112 can be pushed to their intended position on a roller conveyor. For this purpose, as shown in FIG. 1, trolleys 28 (carrier, straddle carrier, rubber tire gantry (RTG), crane, etc.) equipped with a lift can be used.

If the individual components of the wind turbine to be manufactured are provided in a first production step, the floating foundation of the wind turbine must in any case first be produced in a second production step. FIG. 2 shows the previously illustrated harbor 200 during a second production step with the foundation 110 almost completely finished. The foundation 110 shows the characteristic Y-shaped structure made from individual foundation elements 112, on whose central connecting part that connects the individual arms of the floating foundation 110 the tower 120 of the wind turbine to be erected is already arranged with the aid of the auxiliary tower 40 designed as a crane.

Then, in the third production step shown in FIG. 3, the floating bodies 114 are attached to the floating foundation 110. In order to be able to accomplish this in a simple manner, the first pontoon 20 is arranged almost completely within the pivoting range of the crane boom 48, so that every position of the floating foundation 110 can be reached by the trolley 49 displaceably configured on the crane boom 48. The crane boom 48 of the crane designed as an auxiliary tower 40 is arranged at a height that exceeds the height of the floating foundation 110, including the floating body 114 arranged on the floating foundation 110 and the tower 120 arranged on the floating foundation 110; the crane boom 48 rotatably configured on the auxiliary tower 40 can therefore be rotated unhindered at this stage of the erection about the axis of the auxiliary tower 40.

This also applies to the fourth production step shown in FIG. 4 after connection of the floating bodies 114 to the floating foundation 110. In addition to the helicopter landing platform 115 to be attached to the floating body 114 arranged on the long arm of the floating foundation 110, it can be seen that the free end of the tower 120 of the wind turbine to be erected has been prepared to receive the boom. In particular, it can be seen that the free end of the tower 120 above a platform designed as a landing pier for ships is equipped with a support 122, referred to below as a tower connector, which is designed as a mount for the end, to be connected to the tower 120, of the boom. In particular, the support 122 is designed as a joint, so that the booms can be connected to the tower 120 in an articulated manner.

As an alternative to the sequence shown, it is also conceivable that the floating foundation 110 be manufactured at a different location, launched into the water, and towed to the harbor 200 shown. In particular, it is conceivable that the floating foundation 110 be manufactured on a first pontoon 20, which is connected to the second pontoon 30 only after the floating foundation 110 has been completed.

The two booms 130 to be carried by the tower 120 are—as shown in FIG. 5, during a fifth production step in the preparation for connecting the two booms 130 to the tower 120 by means of the tower connector 122, and in FIG. 6, during a sixth production step, booms 130 connected to the tower 120 by means of the tower connector 122—placed in such a way that, with the aid of the auxiliary tower 40 designed as a crane, the one end of the respective boom 130 is supported on or at the free end of the tower 120, and the other end of the respective boom 130, on which an energy conversion unit 150 is already premounted, is supported on each of the two second pontoons 30. The spacers 50 connecting the first pontoon 20 to the second pontoons 30, the joints of which spacers prevent horizontal displacement of the pontoons 20, 30 relative to one another, ensure that the two booms 130 are securely mounted on the two second pontoons 30 and the tower 120 of the wind turbine to be erected.

Both booms 130 are articulated at their one end to the tower 120 or on the tower 120 by means of the tower connector 122, so that they can be pivoted about an essentially horizontal axis and in this way can be raised up to a desired degree. For this purpose, as shown in FIG. 7, the rope system 44 housed in the auxiliary tower 40 is guided out of the auxiliary tower 40 on the upper side of the auxiliary tower 40 by means of deflection rollers (not shown) and is connected to the booms 130 in the region of the energy conversion units 150 connected to the booms 130. At the same time, the two rotors 140, which are preferably designed as two-blade rotors, are provided in a pre-assembled state and, as FIG. 8 shows, mounted on the energy conversion units 150.

In particular, FIG. 8 shows a detail view (A) of a carriage 45, arranged on the rope system 44, which is slidably mounted on the rope system 44 and together with it can be firmly connected thereto while assuming a relatively fixed position on the rope system 44. On the carriage 45, on both sides of the auxiliary tower 40, guy ropes 160 for the anchoring provided between the two energy conversion units 150 of the boom 130 are provided, which—as shown below—are, when the booms 130 are lifted, brought together in the region of the auxiliary tower 40 and are there connected to one another.

After further guy ropes 160—which are required for anchoring the components of the wind turbine and are to connect the energy conversion units 50 not only to one another, but also to two of the arms of the floating foundation 110 in a stabilizing manner—are also connected to these components as a preparatory measure, the booms 130, together with the energy conversion units 150 attached thereto including rotor 140, are lifted from the second pontoons 30 while pivoting about the axes formed on the tower 120 or by the tower 120.

Alternatively, as mentioned above, it is also possible to lift the booms 130 without the rotors 140 being attached thereto. For this reason, however, after the booms 130 have been raised, the rotors 140 would have to be lifted by means of a further crane (not shown) and attached to the energy conversion units 150.

FIG. 9 shows the boom 130 lifted slightly above the horizontal. Previously, the carriages 45 on the rope system 44 were pulled closer in the direction of the tower 45 and fixed on the rope system 44 (cf. detail view (A)), so that the carriages 45 were pulled further together and came to lie adjacent to one another—as shown in FIG. 10—as the boom 130 was lifted. From the working platform arranged on the auxiliary tower 40, which can be seen from the detailed view (A), the ends of the guy ropes 160 attached in the region of the energy conversion units 150 are connected to one another, so that the energy conversion units 150 are supported by the tower 120 and mutually supported by the guy ropes 160. The other guy ropes 160 are also pretensioned to a specific amount, so that the anchoring of the wind turbine 100 receives a predetermined pretensioning overall. In particular, the guy ropes 160 are pretensioned to such an extent that, in every load case to be assumed, none of the guy ropes 160 are relieved to such an extent that they would completely lose their pretensioning. The tensioning and measuring devices required for this purpose for setting the pretensioning of the guy ropes 160 are not shown for reasons of clarity.

After completion of the floating wind turbine 100 and, if necessary, a check of individual components, the state shown in FIG. 10 is reached, in which the floating wind turbine 100 completed in accordance with the previous steps is now completely supported on the first pontoon 20.

To deliver the floating wind turbine 100, the first pontoon 20 is flooded so that the first pontoon 20 and the floating wind turbine 100 are lowered together until the floating wind turbine 100, as shown in FIG. 11, floats independently without the support of the first pontoon 20. The floating wind turbine 100 can then, as FIG. 12 shows, be towed out of the harbor 200 by means of a tug 300 and towed to the site of the installation.

The second pontoons 30, which are connected in an articulated manner to the first pontoon 20, remain on the surface of the water and stabilize the flooded first pontoon 20 on both sides. Due to the rigid connection of the second pontoons 30 to the first pontoon 20, the second pontoons 30 are horizontally offset in the direction of the first pontoon 20. After the first pontoon 20 has been emptied, it re-emerges at the surface of the water, wherein the second pontoons 30 are shifted to their starting position along the quay 210.

FIG. 13 further shows a partial section view of a particularly preferably configured device 10 for erecting the floating wind turbine 100 shown above with two booms 130, connected to a tower 120, at each end of which an energy conversion unit 150 having a rotor 140 is arranged. The device 10 has a first pontoon 20 for holding the floating foundation 110 of a floating wind turbine 100 or of the floating wind turbine 100 after it is produced in its entirety, on each of both sides of which a second pontoon 30 is arranged which is configured for (temporarily) holding an energy conversion unit 150 of the wind turbine 100 that is connected to a boom 130.

As explained above, the first pontoon 20 can be formed from two pontoon elements 20a, 20b. A second pontoon 30 is arranged on each side of the first pontoon 20 and is connected to the first pontoon 20 with the aid of two spacer elements 50. The spacer elements 50 are connected in an articulated manner to both the first pontoon 20 and to the second pontoons 30, wherein the joints have a degree of freedom and are each configured to be rotatable about a horizontally-extending axis. This allows a mobility of the second pontoons 30 relative to the first pontoon 20 in terms of height, i.e., in the vertical direction, e.g., to adapt to waves, but not in their relative horizontal position. This ensures that the end faces of the first pontoon 20 and the second pontoon 30 are always in alignment.

The first pontoon 20 is specifically designed with a plurality of chambers 22, which can be flooded with water by means of at least one pump 24 for generating a desired buoyancy or also emptied by means of the pump 24. The pump(s) 24 are preferably—as the detailed view (A) shows—arranged in a specially designed chamber 23 which is configured to be permanently dry.

On the surface of the first pontoon 20, three conveying paths 26, arranged in a star shape, are provided for transporting foundation modules 112 forming the floating foundation 110. These conveying paths 26 are designed in particular as roller conveyors or as a rail system with trolleys that can be moved thereon and hold the foundation modules 112.

On the first pontoon 20, there is an auxiliary tower 40 arranged centrally to the second pontoons 30, which has, in the foundation of the auxiliary tower 40, i.e., in the first pontoon 20, a winch 42 for a rope system 44, guided within the auxiliary tower 40, for lifting the energy conversion units 150, which are connected by means of the booms 130 to the tower 120 of the wind turbine 100, from the second pontoons 30. The winch 42 as well as the pumps 24 are arranged in a space, formed as a machine room 23 arranged in the first pontoon 20, which space can be accessed from the auxiliary tower 40 or from the surface of the first pontoon 20 and combines mechanical and electrical components. The machine room 23 differs from the chambers 22 in that the machine room 23 is not flooded and is to be kept as dry as possible. Alternatively, the winch 42 and the pumps 24, as well as further mechanical and electrical components, can also be arranged in the tower 40 itself.

A block and tackle 46 communicating with the winch 42 is provided in the auxiliary tower 40. The block and tackle 46 has a block which is configured to be displaceable along the longitudinal axis of the auxiliary tower 40 and which is connected to the rope system 44 for lifting the energy conversion units 150 connected by means of the booms 130 to the tower 120 of the wind turbine 100. In particular, the displaceably-configured block is configured displaceably by means of a lift (not shown). This design allows sufficient transmission of force from the winch 42 to the rope system 44 for lifting the booms 130, wherein it is not the rope system 44 itself, but the rope stored on the winch 42 and guided in the block and tackle 46, that is shortened, wherein the rope system 44, which is connected on one side to the block of the block and tackle 46 and on the other side to the booms 130, can be drawn into the auxiliary tower 40.

The auxiliary tower 40 is also designed as a crane having a crane boom 48, wherein the crane boom 48 is configured to be rotatable about the auxiliary tower 40. Provided on the crane boom 48 is a trolley 49 which can be moved along the crane boom 48 and has a lift for lifting the components of the wind turbine 100 to be manufactured. In particular, the length of the crane boom 48 on one side of the auxiliary tower 40 is dimensioned such that the first pontoon 20 is arranged in the pivoting range of the crane boom 48. Thus, all components of the wind turbine 100 can be placed on the pontoons 20, 30 at the required locations with the aid of the crane.

The second pontoons 30 can be equipped with a resting platform that is adapted to the outer shape of the energy conversion unit 150, which is to be held by the second pontoons 30, of the wind turbine 100.

Finally, FIG. 14 shows an alternative embodiment of a particularly preferably configured harbor 200, which essentially has the properties of the aforementioned embodiment, but in contrast to this, manages without pontoons. For this reason, it is provided that the auxiliary tower 40 be arranged on the harbor area 200, i.e., on the mainland. Accordingly, between the auxiliary tower 40 and the quay 210, an area, which preferably has a slipway, is to be provided on which the floating wind turbine 100 to be erected can be erected and launched into the water. For this purpose, the wall of the quay 210—as can be readily seen from FIG. 14—is lowered in the region of the auxiliary tower 40.

1. An apparatus for erecting a wind turbine with a floating foundation, a tower arranged on the floating foundation, and two booms, extending from the tower, with an energy conversion unit that is arranged in each case at a free end of a boom and has a rotor,
wherein an auxiliary tower with a rope system, connected to a winch, for lifting the energy conversion units that are connected by the booms to the tower of the wind turbine.

2. The apparatus according to claim 1, further comprising a slipway which is arranged adjacent to the auxiliary tower and holds the floating foundation.

3. The apparatus according to claim 1, further comprising a first pontoon for holding the floating foundation, two second pontoons each for holding an energy conversion unit, wherein the second pontoons are arranged on opposite sides of the first pontoon, and the auxiliary tower is arranged centrally to the second pontoons.

4. The apparatus according to claim 3, further comprising spacers connecting the first pontoon to the second pontoon.

5. The apparatus according to claim 4, wherein the spacers are connected in an articulated manner to both the first pontoon (20) and the second pontoon.

6. The apparatus according to claim 4, wherein the joints formed between the pontoons and the spacer have a degree of freedom and are configured to be rotatable about an axis arranged in the plane of the pontoons.

7. The apparatus according to claim 3, wherein the first pontoon is formed from a plurality of interconnected pontoon elements.

8. The apparatus according to claim 3, wherein the first pontoon has a plurality of chambers, wherein at least one pump is provided for flooding and emptying at least one of the chambers.

9. The apparatus according to claim 3, wherein the first pontoon has at least one conveying path for transporting foundation modules forming the floating foundation.

10. The apparatus according to claim 9, further comprising three, star-shaped conveying paths converging towards a central connecting part.

11. The apparatus according to claim 3, wherein the first pontoon has a recess at least partially surrounding the auxiliary tower, wherein the first pontoon is arranged displaceably along the longitudinal axis of the auxiliary tower.

12. The apparatus according to claim 3, wherein the auxiliary tower is arranged on the first pontoon (20).

13. The apparatus according to claim 12, wherein the winch is arranged in the foundation, formed by the first pontoon, of the auxiliary tower.

14. The apparatus according to claim 1, further comprising a block and tackle which is arranged in the auxiliary tower and communicates with the winch.

15. The apparatus according to claim 14, wherein the block and tackle has a block which is configured displaceably along the longitudinal axis of the auxiliary tower and which is connected to the rope system for lifting the energy conversion units that are connected by means of the booms to the tower of the wind turbine.

16. The apparatus according to claim 15, wherein the displaceably-configured block is configured displaceably by a lift.

17. The apparatus according to claim 1, wherein the auxiliary tower is designed as a crane having a crane boom.

18. The apparatus according to claim 17, wherein the crane boom is configured to be rotatable about the auxiliary tower.

19. The apparatus according to claim 3, wherein the first pontoon is arranged in the pivoting range of the crane boom.

20. A harbor with a quay and the apparatus according to claim 1 which is attached to the quay in a floating manner.

21. A harbor with a quay and the apparatus according to claim 9, which is attached to the quay in a floating manner and further comprising a second conveying path arranged on the quay and communicating with the conveying path arranged on the first pontoon.

22. A method for erecting a wind turbine having a floating foundation, a tower arranged on the floating foundation, and two booms, extending from the tower, each having an energy conversion unit arranged at a free end of a boom,
comprising the steps of:
producing a floating foundation with a tower arranged thereon;
setting up at least one support, arranged on the tower, for receiving one end of each of the booms, which may be connected to an energy conversion unit (150);
arranging one end of each of the booms on the support and arranging the one end of each of the other booms at the height of the tower base;
lifting the other end, mounted at the height of the tower base, of each of the booms as the booms are simultaneously pivoted with the at least one support acting as a seat until a predetermined height is reached;
fixing the one ends of the pivoted booms on the tower; and
forming an anchoring between the other ends of the pivoted booms or between the energy conversion units by at least one guy rope.

23. The method according to claim 22, further comprising the further step of: attaching a rotor to each of the energy conversion units.

24. The method according to claim 23, wherein the attachment of the rotors to the energy conversion units takes place before the booms are lifted.

25. The method according to claim 22, wherein the booms (130) are lifted simultaneously by the same amount.

26. The method according to claim 22, wherein the support is designed as a joint.
